(19) United States
(12) Patent Application Publication
(10) Pub. No.: US 2025/0390796 A1
(43) Pub. Date: Dec. 25, 2025

(54) DIGITAL PLATFORM MATRIX FEATURE GENERATION

(71) Applicant: ADP, LLC, Roseland, NJ (US)

(72) Inventor: Buchi Bharath, Hyderabad (IN)

(73) Assignee: ADP, LLC, Roseland, NJ (US)

(21) Appl. No.: 19/245,931

(22) Filed: Jun. 23, 2025

(30) Foreign Application Priority Data
Jun. 24, 2024 (IN) 202411048450

(51) Int. Cl. G06N 20/00

(52) U.S. Cl. CPC G06N 20/00

(57) ABSTRACT

Machine learning based checklist feature generation is provided. The system can include one or more processors configured to access a first matrix to control execution of operations. The one or more processors can transform the first matrix into a second matrix corresponding to an input for a machine learning (ML) model. The one or more processors can generate, using the ML model, an output based on the second matrix. The one or more processors can identify, by the ML model, one or more metrics that from a computing device. The one or more processors can update, the ML model using the one or more metrics from the computing device.

### CROSS-REFERENCE TO RELATED APPLICATION

This application claims the benefit of priority under 35 U.S.C. § 119 to Indian Provisional Application No. 202411048450, filed Jun. 24, 2024, which is hereby incorporated by reference herein in its entirety.

### TECHNICAL FIELD

This application is directed to computing system technology, and, more particularly, to a computing system that generates matrix features with digital platforms.

### BACKGROUND

As formats and volume of electronic forms for operations within an entity being executed by computing systems increase and become more complex, it can be challenging to maintain compatibility of such forms across an entity without introducing excess computer resource utilization, memory utilization, network bandwidth consumption, and latency or delay.

### SUMMARY

Aspects of technical solutions described herein are directed to a digital platform that generates matrix features. The digital platform can facilitate operations to be ordered by priority during the year-end or quarter-end. For example, due to the volume of operations, duties, or assignments, it can be challenging to monitor, track, or manage the various operations during the year-end or quarter-end associated with each computing device or computing system within the entity. Generating or determining operations for each sector within an enterprise or entity can result in excessive time and wasted computer resources as the operations are generated for each cycle of the year-end or quarter-end. Constantly generating the operations can result in excess computer resource utilization, memory utilization, network bandwidth consumption, and latency or delay in the process of distributing the operations to one or more computing systems or computing devices.

Systems and methods of this technology can provide a digital platform (or platform) using a machine learning model-based checklist feature. The platform can access a database to retrieve a first matrix to control the execution of operations. When the platform receives an indication that the year-end or quarter-end is approaching, the platform can scan a plurality of operations corresponding to the year-end or quarter-end from the first matrix. The operations can correspond directly to the entity associated with the first matrix. The platform can transform, generate, or manipulate the first matrix into a second matrix that is compatible with a machine learning (ML) model. Upon transforming the first matrix into the second matrix, the second matrix can be fed into the ML model for processing. For example, the platform can transform the first matrix into a second matrix. The second matrix can represent a feature vector for the ML model. The ML model can generate an output based on the second matrix. The output can be a third matrix that represents one or more operations for the entity. The one or more operations can include a priority for each operation, resources to complete the one or more operations, and designations for one or more people to execute the one or more operations.

Using the ML model can reduce complexity on the computing devices for entities to generate the operations for the year-end or quarter-end by creating a one-size-fits-all approach for ease across entities when generating the operations. Furthermore, the ML model can create operations much faster than using conventional methods for operation generation. The ML model can identify one or more metrics to indicate a compatibility of the operations. For instance, the ML model can generate operations that are not relevant to a sector within the entity. The ML model can use a deviation based on the compatibility of the output to improve the ML model to generate operations relevant to each sector within the entity. The one or more metrics can indicate an accuracy of the one or more operations and a quality of the one or more operations. The one or more metrics can update the ML model by using the metric to adjust one or more parameters associated with the ML model.

An aspect of the technical solution described herein can be directed to computing system for human resources compliance management. The system can include memory. The system can include one or more processors configured to access a first matrix to control execution of operations. The execution of operations can be based on associated entity data. The one or more processors can transform the first matrix into a second matrix corresponding to an input for a machine learning (ML) model. The one or more processors can generate, using the ML model, an output based on the second matrix. To generate the output, the one or more processors can apply the second matrix as an input to the ML model. The output can include a third matrix corresponding to one or more operations for the associated entity data, a priority for each operation in the one or more operations, and one or more resources to execute the one or more operations. The one or more processors can identify, by the ML model, one or more metrics that indicate compatibility of the output, accuracy of the output, and quality of the output from a computing device. The compatibility of the output can be determined based on an interaction with the output. The accuracy of the output can be determined based on a level of deviation from reference entity data and reference operations. The quality of the output can be based on a level of deviation from a reference format of the second data within the output. The one or more processors can update the ML model using the one or more metrics from the computing device.

An aspect of the technical solution described herein can be directed to a method. The method can be performed by one or more processors, coupled with memory. The method can include accessing a first matrix to control execution of operations. The execution of operations can be based on associated entity data. The method can include transforming the first matrix into a second matrix corresponding to an input for a machine learning (ML) model. The method can include generating, using the ML model, an output based on the second matrix. To generate the output, the method can include applying the second matrix as an input to the ML model. The output can include a third matrix corresponding to one or more operations for the associated entity data, a priority for each operation in the one or more operations, and one or more resources to execute the one or more operations. The method can include identifying, by the ML model from a computing device, one or more metrics that indicate compatibility of the output, accuracy of the output, and quality of the output from a computing device. The compatibility of the output can be determined based on an interaction with the output. The accuracy of the output can be determined based on a level of deviation from reference entity data and reference operations. The quality of the output can be based on a level of deviation from a reference format of the second data within the output. The method can include updating, the ML model using the one or more metrics from the computing device.

An aspect of the technical solution described herein can be directed to a non-transitory computer-readable medium that stores processor-executable instructions that, when executed by one or more processors, cause the one or more processors to access a first matrix to control execution of operations. The execution of operations can be based on associated entity data. The one or more processors can transform the first matrix into a second matrix corresponding to an input for a machine learning (ML) model. The one or more processors can generate, using the ML model, an output based on the second matrix. To generate the output, the one or more processors can apply the second matrix as an input to the ML model. The output can include a third matrix corresponding to one or more operations for the associated entity data, a priority for each operation in the one or more operations, and one or more resources to execute the one or more operations. The one or more processors can identify, by the ML model, one or more metrics that indicate compatibility of the output, accuracy of the output, and quality of the output from a computing device. The compatibility of the output can be determined based on an interaction with the output. The accuracy of the output can be determined based on a level of deviation from reference entity data and reference operations. The quality of the output can be based on a level of deviation from a reference format of the second data within the output. The one or more processors can update the ML model using the one or more metrics from the computing device.

These and other aspects and implementations are discussed in detail below. The foregoing information and the following detailed description include illustrative examples of various aspects and implementations and provide an overview or framework for understanding the nature and character of the claimed aspects and implementations. The drawings provide illustrations and a further understanding of the various aspects and implementations and are incorporated in and constitute a part of this specification. The foregoing information and the following detailed description and drawings include illustrative examples and should not be considered as limiting.

### BRIEF DESCRIPTION OF THE DRAWINGS

Aspects of the technical solutions of this application are described in the detailed description which follows, in reference to the noted plurality of drawings by way of non-limiting exemplary embodiments of the present description.

FIG. 1 is an illustrative example of a system for a platform using a machine learning (ML) model checklist feature according to an illustrative embodiment;

FIG. 2 is an illustrative example of a year-end checklist, according to an illustrative embodiment;

FIG. 3 is an illustrative example of the year-end checklist output by the ML model, according to an illustrative embodiment; and

FIG. 4 is a flowchart for a method for a platform using a machine learning (ML) model checklist feature, according to an illustrative embodiment.

### DETAILED DESCRIPTION

Aspects of the technical solutions described herein are directed to a matrix feature generation with a digital platform using a machine learning (ML) model checklist feature. The platform can allow for the operations to be ordered by priority during the year-end or quarter-end. For example, due to the volume of operations, duties, or assignments, it can be challenging to monitor, track, or manage the various operations during the year-end or quarter-end. Generating or determining operations for each sector within an enterprise or entity can result in excess time and wasted computer resources as the operations are generated for each cycle of the year-end or quarter-end. Constantly generating the operations can result in excess computer resource utilization, memory utilization, network bandwidth consumption, and latency or delay in the process of distributing the operations to one or more computing systems or computing devices.

The systems and methods described herein resolve these issues by streamlining various processes, such as data processing, form submission, and data updates. For instance, the system can automatically trigger data processing by integrating with various platforms (e.g., a payroll dashboard via APIs), eliminating the need for manual navigation. Similarly, operations (e.g., submitting reports and W-2/1099 forms) can be automated by generating pre-filled data objects based on data from the database, reducing manual data entry. The ML model suggests corrections for employee information and applies them directly to the database using SQL updates.

Real-time compliance updates are achieved by integrating with external data sources, allowing the system to automatically update checklists with new regulations. Automated compliance checks ensure operations align with regulations, flagging errors for review. The ML model assigns priorities and statuses to schedule operations automatically, triggering reminders and enforcing operation dependencies. Resource provisioning and guidance are provided through the checklist, linking to automated workflows and executing scripts to retrieve relevant data. NLP-generated recommendations can trigger automated actions, further streamlining operation execution. Progress tracking and feedback automation enable real-time updates on operation status, sending automated progress reports to HR practitioners or managers. Feedback on operation relevance is fed back to the ML model, improving future operation generation. User interface automation filters and displays operations based on user preferences, sending automated notifications for overdue operations or regulatory changes. This comprehensive automation framework ensures continuous execution and optimization of HR operations, enhancing efficiency and accuracy of the various operations performed within the checklist matrix.

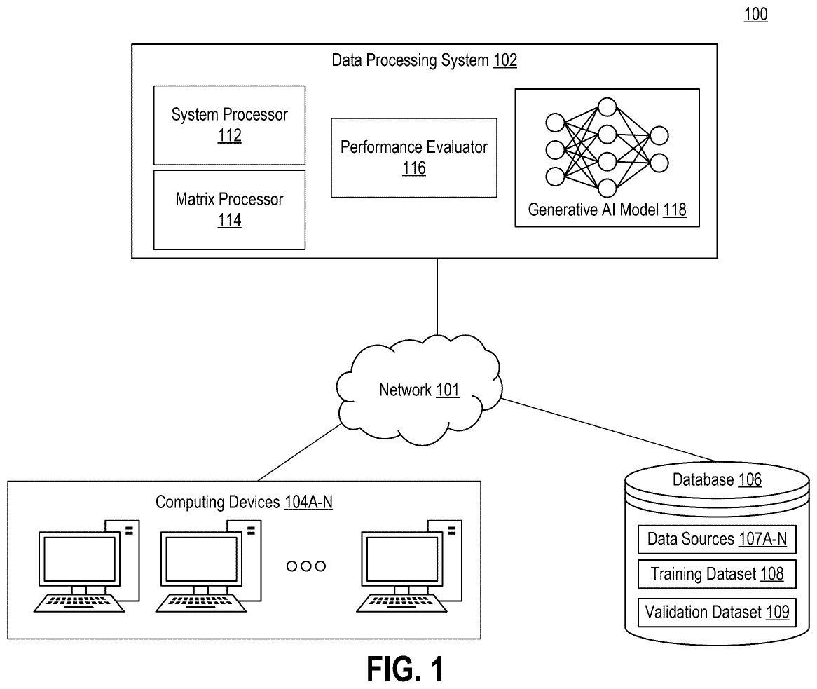

FIG. 1 is an illustrative example of a system 100 for human resource compliance management. The system 100 can include at least one data processing system 102, computing devices 104A-N (generally referred to as a “computing device 104” and as “computing devices 104”), and database 106. The above-mentioned components may be connected to each other through a network 101. The examples of the network 101 may include, but are not limited to, private or public Local-Area Network (LAN), Wireless Local-Area Network (WLAN), Metropolitan-Area Network (MAN), Wide-Area Network (WAN), and the Internet. The network 101 may include both wired and wireless communications according to one or more standards and/or via one or more transport mediums.

The communication over the network 101 may be performed in accordance with various communication protocols such as Transmission Control Protocol and Internet Protocol (TCP/IP), User Datagram Protocol (UDP), and IEEE communication protocols. In one example, the network 101 may include wireless communications according to Bluetooth specification sets, or another standard or proprietary wireless communication protocol. In another example, the network 101 may also include communications over a cellular network, including, e.g., a GSM (Global System for Mobile Communications), CDMA (Code Division Multiple Access), EDGE (Enhanced Data for Global Evolution) network.

The system 100 is not confined to the components described herein and may include additional or alternate components, not shown for brevity, which are to be considered within the scope of the embodiments described herein.

The computing devices 104 of the system 100 may hardware and software components configured to perform the various processes and operations described herein, including one or more processors or software comprising machine-executable instructions executed by the one or more processors. Non-limiting examples of such computing devices 104 of the system 100 include server computers, laptop computers, desktop computers, tablet computers, and smartphone mobile devices, among others. The computing devices 104 may execute webserver software for hosting one or more webpages according to web-related or data-communications protocols and computing languages.

The system 100 can include at least one database 106. The database 106 can store various types of data related to data sources, entity data, records, computing device 104 information, among others. The data processing system 102 can access the database 106 when the one or more components of the data processing system 102 requires information or data to execute the digital platform for HR compliance management. The database 106 can include data sources 107A-N (generally referred to as “data sources 107” or a “data source 107” and a training dataset 108. In operation, one or more computing devices 104 sends a plurality of operations over the network 101 to the data processing system 102 for the formulation of the HR compliance platform. The data processing system 102 can send or transmit the plurality of operations to the database 106 and retrieves one or more data sources 107 associated with the plurality of operations. The database 106 can include one or more hardware memory devices to store binary data, digital data, or the like. The database 106 can include one or more electrical components, electronic components, programmable electronic components, reprogrammable electronic components, integrated circuits, semiconductor devices, flip flops, arithmetic units, or the like. The database 106 can include at least one of a non-volatile memory device, a solid-state memory device, a flash memory device, and a NAND memory device. The database 106 can include one or more addressable memory regions disposed on one or more physical memory arrays. A physical memory array can include a NAND gate array disposed on, for example, at least one of a particular semiconductor device, integrated circuit device, or printed circuit board device.

The data processing system 102 of the system 100 can include one or more of a system processor 112, matrix processor 114, performance evaluator 116, or generative artificial intelligence (AI) model 118 (generally referred to as machine learning (ML) model 118). The system processor 114 and the matrix processor 114 can execute one or more instructions associated with the data processing system 102. The system processor 112 and matrix processor 114 can include an electronic processor, an integrated circuit, or the like including one or more of digital logic, analog logic, digital sensors, analog sensors, communication buses, volatile memory, nonvolatile memory, and the like. The system processor 112 and matrix processor 114 can include, but are not limited to, at least one microcontroller unit (MCU), microprocessor unit (MPU), central processing unit (CPU), graphics processing unit (GPU), physics processing unit (PPU), embedded controller (EC), or the like. The system processor 112 and matrix processor 114 can include memory operable to store or storing one or more instructions for operating components of the system processor 112 and matrix processor 114 and operating components operably coupled to the system processor 112 and matrix processor 114. For example, the one or more instructions can include one or more of firmware, software, hardware, operating systems, embedded operating systems. The system processor 112, matrix processor 114 or the data processing system 102 generally can include one or more communication bus controllers to effect communication between the processors and the other elements of the data processing system 102.

The system processor 112 can receive, access, or identify a plurality of operations from the computing devices 104. The plurality of operations can correspond to the associated entity (e.g., type of entity, data associated with the entity). For example, in an accounting entity, the plurality of operations can include recording financial transactions, creating budgets, forecasting financial outcomes, managing cash flow, among others. In other examples, within human resources of an entity, the plurality of operations can include accessing future staffing needs, posting job offerings, screening resumes and applications, setting performance expectations, among others. The computing devices 104 can transmit the plurality of operations over the network 101 by executing one or more commands to access the system 100. In some instances, the computing devices 104 can access the system 100 through a webpage, application, web-domain, or other computer software specific to the entity.

The system processor 112 can access the database 106 to retrieve data or information from the data sources 107. The data can include one or more of structured data stored in relational databases (e.g., records, entity attributes, payroll data), unstructured data (e.g., text from electronic communications, text from policy documents), temporal data (e.g., dates, schedules, task due dates, schedules), and external data (e.g., data from the various data sources 107 accessed using one or more APIs, data scraped from government websites, regulatory data, industry parameters). The data sources 107 can refer to locations or origins within an entity for obtaining, collecting, or extracting data. The data sources 107 can include internal data associated with the entity. For example, the internal data of the data sources 107 can include payroll systems, employee databases, tax authorities, among others. The data sources 107 can include external data stored as one or more databases within the data sources 107. For example, data source 107C can correspond to a database for industry-specific information associated with the entity. In another example, data source 107D can correspond to a database for third-party information associated with the entity. In some embodiments, the data sources 107 can be information collected from websites, web scraping, and web analytics tools. In some embodiments, the data sources 107 can include open data provided by government agencies, research institutions, among others.

The system processor 112 and the matrix processor 114 can preprocess the data from the data sources 107 and the plurality of operations. Data preprocessing can involve cleaning, transformation, and preparation of raw data (e.g., unprocessed data, noisy data, unstructured data, etc.) into a format suitable for the ML model 118. For example, the system processor 112 can identify and address missing data (e.g., errors) within the database 106 (e.g., data points of the data sources 107). Missing data can include Not a Number (NaN), missing rows or columns of a data table, or special codes for categorical data. The system processor 112 may generate an indicator that is assigned to each instance of missing data within the database. For example, a missing data indicator can indicate that a value, word, or phrase is missing to the ML model 118. In some embodiments, the missing data indicator can enable the ML model 118 to predict, guess, and estimate the values, words, or phrases to place in the missing data indicator by using the plurality of data sources or a subset of the plurality of data sources that include values for the data points to remove the missing data indicator.

The system processor 112 and the matrix processor 114 can clean the data from the data sources 107. To clean the data, the system processor 112 and the matrix processor 114 can remove or correct any errors, inconsistencies, duplicates, or missing values detected in the data. For example, if the entity data has some typos or spelling mistakes in the entity name, location, or industry, such as “Amazn,” “Seatle,” or “E-comerce,” they can be cleaned by replacing them with the correct values, such as “Amazon®,” “Seattle,” or “E-commerce.” In some arrangements, the matrix processor 114 can query the database 106 to extract or obtain references to correct the errors, inconsistencies, duplicates, or missing values. For example, the database 106 can provide a web-domain (e.g., seattle.gov, seahawks.com) to correct the error of the spelling of “Seatle.”

The system processor 112 and the matrix processor 114 can filter the data from the data sources 107. To filter the data, the system processor 112 and matrix processor 114 can select, identify, include, or exclude certain data based on one or more criteria or conditions. For example, if the checklist data has some irrelevant or outdated items that are not applicable to the current year-end or quarter-end tasks, such as “File Form 1099-MISC for nonemployee compensation” (which was replaced by Form 1099-NEC in 2020), they can be filtered out by checking the due date or the validity of the items.

In further detail, the system processor 112 can filter the data based on relevance. The relevance can include operations applicable to a company or entities attributes (e.g., location, industry, etc.) For example, rule-based filtering can be executed to filter based on relevance (e.g., if state!=‘CA’ then include FUTA operation) or by ML-based relevance scoring. In ML-based relevance scoring, the ML model 118 can indicate which data to filter in accordance with a compatibility score.

The system processor 112 can filter the data based on temporal filters. The system processor 112 can exclude operations with expired or terminated due dates or include obsolete formatting. For example, the system processor 112 can use or execute conditional logic based on regulatory change logs associated with the checklist. The system processor 112 can filter the data based on status filters. The system processor 112 can provide or display the operations by status (e.g., completed, in progress, not started) based on one or more database queries or a user interface toggle on the computing device 104. The system processor 112 can filter the data based on priority filters. The system processor 112 can display or prioritize operations based on importance or urgency by including a flag or indication on the one or more outputs of the ML model 118.

The system processor 112 and the matrix processor 114 can label the data from the data sources 107. To label the data, the system processor 112 and the matrix processor 114 can assign, add, or attach labels and/or tags to the data to make it easier to identify or classify. For example, if checklist data contains items that have different priority levels, such as high, medium, or low, the checklist data can be labeled by adding a prefix or a suffix to the item name, such as “[H] File Form W-2 for wages and taxes” or “Update employee benefits [L]”. In some arrangements, the prefixes can be adjusted to correspond to the entity data. The matrix processor 114 can form the preprocessed data and the plurality of operations into a matrix. The matrix can be a table, a checklist, or a form to display and control the execution of each operation in the plurality of operations.

The matrix processor 114 can transform the matrix into a second matrix or an input matrix. Transforming the matrix can include normalizing, handling, or formatting the data within the matrix. For example, the matrix processor 114 can format dates, times, and other types of temporal data to maintain consistency across the matrix. In another example, the matrix processor 114 can remove irrelevant characters, punctuation, formatting inconsistencies from the text data within the matrix. In some embodiments, using the matrix processor 114 to correct the input matrix can train the ML model 118 to identify a correct format for the data within the input matrix. For example, an operation within the matrix can state, “Subscripe to company protocols.” The ML model 118 can correct the operation to state “Subscribe to company protocols,” based on a correction in a previous operation made by the matrix processor 114.

The matrix processor 114 can feed the input matrix as an input into the ML model 118. The ML model 118 can leverage one or more AI techniques such as natural language processing, sentiment analysis, topic modeling, data mining, deep learning, among others. For example, the ML model 118 can utilize tokenization to break down the operations into tokens or individual words. In another example, the ML model 118 can use Sentiment analysis to find an emotional tone for the operations. Furthermore, the ML model 118 can develop an emotional tone for the operations and develop a priority for the operations. In another example, the ML model 118 can use data mining to discover patterns between one or more operations within the input matrix.

In some cases, the model 118 can include a generative artificial intelligence model, such as a large language model, transformer-based neural network. For example, the model 118 can include a transformer-based language model that employs deep learning techniques, such as self-attention mechanisms, which is configured to process and generate text.

The ML model 118 can generate an output based on the input matrix. To generate the output, the ML model 118 can apply the one or more AI techniques to the input matrix. Applying the one or more AI techniques can include accessing and integrating entity data from the one or more data sources 107. For example, the ML model 118 can access and integrate payroll systems from the corresponding entity. In another example, the ML model 118 can aces and integrate tax authorities associated with the corresponding entity. The ML model 118 can leverage one or more data integration tools and APIs to access the information within the data sources 107.

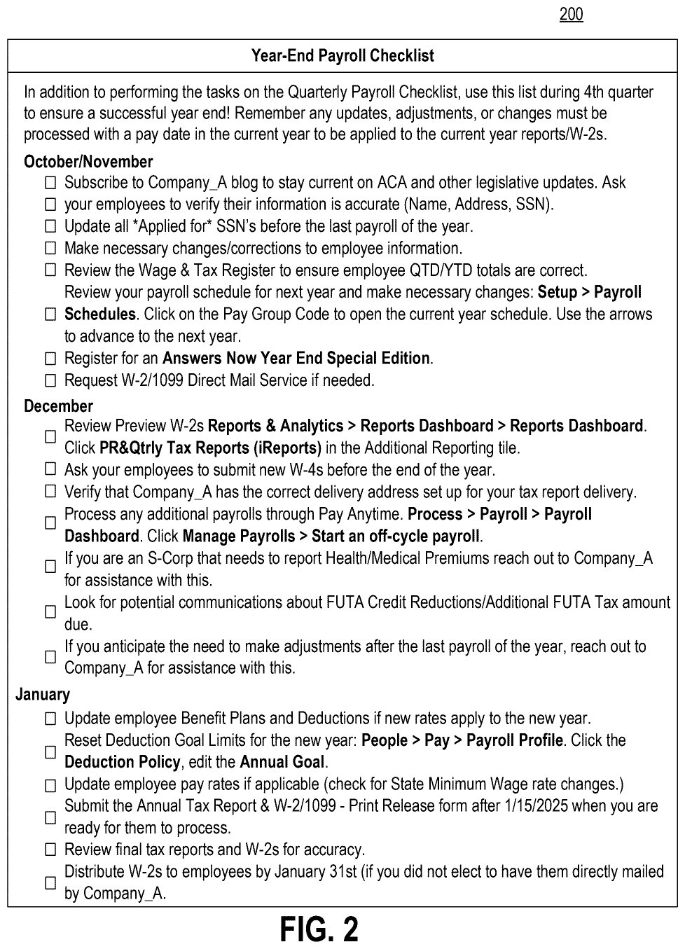

The ML model 118 can generate personalized and accurate operation items for the year-end and quarter-end operations for each entity. The personalized operation items can include an application, interface, or platform for each individual within the entity using configured settings by the individual. FIG. 2 depicts a year-end checklist 200. The year-end checklist 200 does not include any personalization and depicts each operation as a list, organized by date. The year-end checklist 200 may not include a prioritization for the operations which may lead to the completion of a first operation where a second operation needs to be completed. Therefore, the ML model 118 can prioritize, track, and update the operation items using an urgency for the operation items. For example, an operation from the year-end checklist 200 within the data sources 107 can state, “Request W-2/1099 Direct Mail service.” The ML model 118 can decide to that the operation is high urgency based on a deadline for the operation. In another example, an operation from the year-end checklist 200 within the data sources 107 can state, “Make necessary corrections to employee information.” The ML model 118 can assign a low priority to the operation because the ML model 118 can make the necessary changes itself.

The ML model 118 can prioritize, track, and update the operation items using a status for the operation items. The status can indicate whether the operation is “completed,” “in progress,” “not started,” or “cancelled.” For example, the operation “Subscribe to ADP's SPARK blog” can have a status of “not started,” indicating to the ML model 118 to prioritize the operation. In another example, the operation “Preview W-2” can have a status of “in progress,” indicating to the ML model 118 to prioritize an operation that was not started. The ML model 118 can prioritize, track, and update the operation items using an importance for the operation items. The ML model 118 can assign the importance corresponding to deadlines for the operation, an estimated length of time to complete the operation, and/or a degree of difficulty for the operation. For example, the operation “Update employee pay rates” can be a difficult and time-consuming operation. Therefore, the ML model 118 can assign a high importance because of the degree of difficulty and the length of time to complete the operation.

The ML model 118 can provide guidance and resources on how to complete each operation item using natural language processing and machine learning APIs and models. The training dataset 108 can include a corpus for natural language processing. The corpus can include an association of texts with images. The text of a corpus may contain a large set of text to be representative of a language. The corpus may provide examples of how the language is used in a variety of situations such as language for a user in who is a manager for HR, entry-level in HR, senior in HR, among others. Furthermore, the images of the corpus may be presented to the ML model 118 to recognize and interpret images for operation item sent by the user. The training dataset 108 can further include descriptions for each operation item in the matrix and various requirements to train the ML model 118. In some instances, each item within the training dataset 108 can be labeled with a priority to train the ML model 118 to generate recommendations based on the priority. The training dataset 108 can be formatted in accordance with an input to the generative AI model 118.

Using the text strings of the corpus, the ML model 118 can generate string recommendations for the operation items. For example, for each operation in the year-end checklist 200, the ML model 118 can give an itemized recommendation to complete each operation within the year-end checklist 200. The recommendation can address the urgency, status, or the importance of the operation to complete the operation with maximum efficiency. The recommendation can suggest one or more data sources 107 to complete the operation. For example, the ML model 118 can include the recommendation for the operation “Pay additional payroll through pay anytime.” The recommendation can include “Process>Payroll>Payroll Dashboard” corresponding to the data source 107 to help complete the operation.

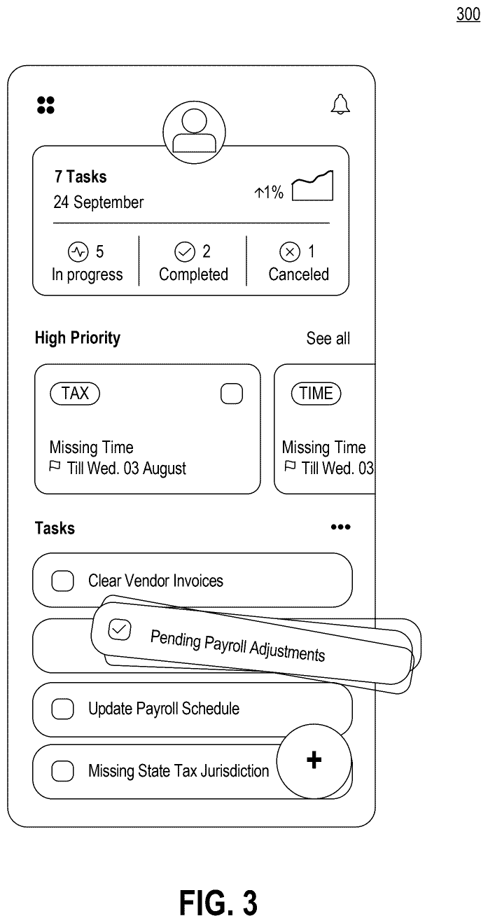

The ML model 118 or the system processor 112 can display the checklist items, resources, operations, and settings on a user-friendly and responsive web interface using web development and data visualization tools. Referring now to FIG. 3, FIG. 3 is an illustrative example of the year-end checklist 300 (referred to as “interface 300” herein) output by the ML model 118. The interface 300 can be customized based one or more requests, the relevancy of the output, the accuracy of the output, and the quality of the output. For example, the interface 300 can hide the operations which include a “not started” status and include operations which are “completed”, “in progress”, and “cancelled.” The ML model 118 can include operations with a high priority on the interface 300. Therefore, the system processor 112 can around the operations in accordance with the priority such that high priority is visible first on the list. In some instances, the system processor can arrange the operations based on information associated with the user (e.g., user division within the entry, team within the entity, previously completed operations or tasks, etc.). In some embodiments, the system processor 112 can display the total number of operations to complete on interface 300. In this manner, the system processor 112 and the ML model 118 can automatically provide the operations for display based on previous number of interactions (e.g., relevancy of the output) with one or more operations generated by the ML model 118. In some embodiments, the performance evaluator 116 can use the validation dataset 109 provide feedback to the ML model 118.

The validation dataset 109 can include a plurality of reference operations and formats to evaluate the outputs of the ML model 118. The plurality of reference operations and formats can be based on outputs previously generated by the ML model 118 that satisfy an accuracy threshold, matrices populated by an administrator, or matrices extracted from the data sources 107. The plurality of reference operations and formats include ground truths for the generated checklists for each level of granularity (e.g., industry, company). The validation dataset 109 can be updated by the performance evaluator 116 can each instance or iteration of execution of the ML model 118.

The system processor 112 or the matrix processor 114 can transmit the operation matrix and the interface 300 to the computing devices 104 to display on the user interface. The computing devices 104 can review the interface 300 and the operation items and transmit feedback to the data processing system 102. The performance evaluator 116 can receive feedback regarding the operation matrix and the interface 300 generated by the ML model 118. The feedback can include one or more metrics for the operation items and the interface 300. The one or more metrics can indicate compatibility of the interface 300, accuracy of the interface 300, and quality of the interface 300 from the computing device 104. The performance evaluator 116 can use the metrics as a loss function to improve the outputs of the ML model 118. The loss function can include a loss metric which can be a value that represents a summation of error in a machine learning model (e.g., ML model 118) calculated by the loss function, such as Cross-Entropy or Mean Squared Error, or by the compatibility, accuracy, and/or quality of the interface 300.

The compatibility of the interface 300 can correspond to one or more cancellations between the computing devices 104 and the interface 300. For example, the computing device 104A can cancel one or more operations on interface 300 if the operations are relevant to the year-end checklist 200 in the validation dataset 109. The number of cancellations in the interface 300 can indicate that the operation items are not relevant. In this manner, the performance evaluator 116 can improve the ML model 118 to reduce the number of cancellations in the interface 300. The accuracy of the interface 300 can correspond to a level of deviation from the validation dataset 109. The system processor 112 or the performance evaluator 116 can update the validation dataset 109 at each occurrence of the ML model 118 generating the interface 300. The validation dataset 109 can include one or more operations to correspond to each computing device 105.

The performance evaluator 116 can calculate the level of deviation between the operations of the interface 300 and the operations within the validation dataset 109. For example, the interface 300 can include eight operations for employee A, but the validation dataset 109 can have 10 operations corresponding to employee A. Therefore, the performance evaluator 116 can calculate a high level of deviation for the accuracy of the interface 300. In another example, the operation of the interface 300 for employee B can match each operation in the validation dataset 109 for employee B. In some embodiments, the system processor 112 or the performance evaluator 116 can update the validation database 109 using data from the data sources 107. The quality of the interface 300 can correspond to the format of the operations in the validation dataset 109. The format of the operation in the validation dataset 109 can indicate, identify, or otherwise determine a correct prioritization of the operations within the year-end checklist 200. For example, the operation “Register for an Answers Now Year End Special Edition” can be high priority in the validation dataset 109, but the interface 300 can have the operation be low priority. Therefore, the performance evaluator 116 can determine that the interface 300 is not of a proper quality.

The user interface 300 can further include display options such that users can hide or show operations based on status (e.g., hide “not started” operations) by using JavaScript (e.g., or other types of API) in the web interface to toggle visibility based on user-selected filters (e.g., document.querySelector(‘.operation’).style.display=‘none’ for filtered operations). The interface 300 can change or modify in accordance with user roles (e.g., HR Specialist vs. HR Director) by displaying relevant operations or metrics. For example, an HR Director may see aggregated operation completion statistics, while an HR Specialist sees operation-specific instructions. The interface 300 can further include one or more development frameworks (e.g., React, per general web technology trends) to ensure compatibility across the computing devices 104 (desktops, tablets, smartphones). The interface 300 can include the ML model generated operations based on company attributes (e.g., minimum wage updates for California at $15.50/hour vs. New York at $14.20/hour, per Page 4). This uses conditional logic or feature vectors encoding company details (e.g., {state: ‘CA’, min_wage: 15.50}).

As displayed on the interface 300, the ML model can assign and display priorities (e.g., high for “File W-2” due to regulatory deadlines) and suggests resources (e.g., “Process >Payroll >Payroll Dashboard” for additional payrolls based on NLP analysis of operation descriptions and integration with data sources 107 via APIs. The system process 112 can update operations in real-time (e.g., near real time) based on data changes (e.g., new regulations or employee data updates), using event-driven triggers or scheduled data pulls. The interface 300 can be configured to receive user feedback (e.g., operation cancellations) and adjust the ML model to refine operation relevance. For example, if a user cancels an operation deemed irrelevant, the model updates its weights to prioritize more relevant operations in future iterations, using backpropagation in the neural network.

Using the metric, the performance evaluator 116 can update the ML model 118. Updating the ML model 118 can include adjusting, changing, or leveraging one or more parameters of the ML model 118. The performance evaluator 116 can use the metric to improve the accuracy, the quality, and the compatibility of the interface 300. For example, the performance evaluator 116 can store an interface 300 with a high accuracy in the training dataset 108 to improve the ML model 118. In another example, the performance evaluator 116 can disregard an interface 300 with a low accuracy and use the corresponding operation items in the validation dataset 109 to train the ML model 118.

In this manner, the systems and methods described herein include various technological advantages. For instance, using the systems and methods described herein can automatically establish or provide a standardized format for the data fed into the machine learning model thereby improving the efficiency of the execution of the ML model. The standardized format can reduce wasted computing resources needed to complete missing, stale, or incorrect (e.g., erred) values within the data by executing the ML model trained on the standardized format. This allows the ML model or the data processing system to quickly identify a location within the database or at least one data source to correct the erred value. Therefore, allowing a computer executing the systems and methods described herein to quickly execute queries while saving on memory and utilization. The systems and methods described herein can further reduce computing resources by generating a user interface that includes elements organized and placed in a manner to warren interactions with a user or administrator. In this manner, one or more elements can be excluded from or not visible on the user interface based on accuracy of the output (e.g., number of operations), relevancy or compatibility of the output (e.g., usage), and the quality of the output. Furthermore, the systems and methods described herein strive to efficiently improve the ML model by implementing the one or more metrics and updating one or more parameters of the ML model for a respective user or subset of users. The systems and methods described herein further use feedback received from a computer device to update a validation dataset. Thereby updating the ML model in accordance with the validation data set during training.

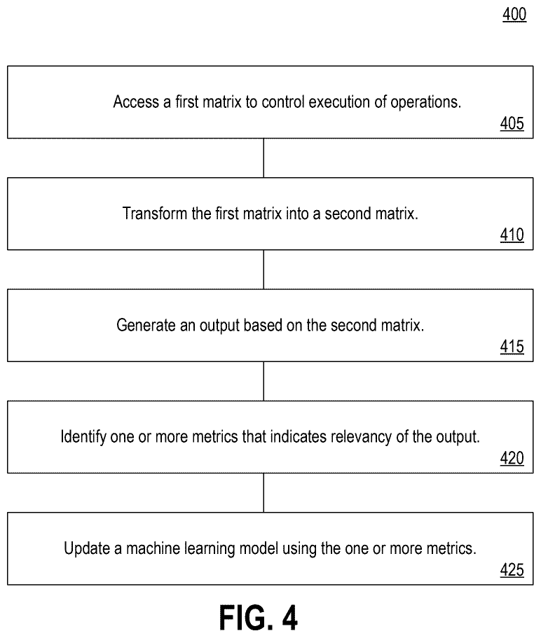

FIG. 4 depicts a method 400 for human resource compliance management. The method 400 can be performed by, using, or for a system 100 or a computing device 105. The method 400 can include accessing a first matrix to control execution of operations at ACT 405. The method 400 can include transforming the first matrix into a second matrix at ACT 410. The method 400 can include generating an output based on the second matrix at ACT 415. The method 400 can include identifying one or more metrics that indicate a compatibility, an accuracy, and a quality of the output at ACT 420. The method 400 can include updating a machine learning (ML) model using the one or more metrics.

The foregoing examples have been provided merely for the purpose of explanation and are in no way to be construed as limiting of the present description. While aspects of the present description have been made with reference to an exemplary embodiment, it is understood that the words which have been used herein are words of description and illustration, rather than words of limitation. Changes can be made, within the purview of the appended claims, as presently stated and as amended, without departing from the scope and spirit of the present description in its aspects. Although aspects of the present description have been made with reference to particular means, materials and embodiments, the present description is not intended to be limited to the particulars disclosed herein; rather, the present description extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts, and those elements can be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present description.

What is claimed is:

1. A computing system, comprising:
one or more processors, coupled with memory, to:
access a first matrix to control execution of operations, the execution of operations based on associated entity data;
transform the first matrix into a second matrix corresponding to an input for a machine learning (ML) model;
generate, using the ML model, an output based on the second matrix, wherein generating the output comprises applying the second matrix as an input to the ML model, wherein the output comprises a third matrix corresponding to one or more operations for the associated entity data, a priority for each operation in the one or more operations, and one or more resources to execute the one or more operations;
identify, by the ML model, one or more metrics that indicate compatibility of the output, accuracy of the output, and quality of the output, wherein the compatibility of the output is determined based on an interaction with the output, wherein the accuracy of the output is determined based on a level of deviation from reference entity data and reference operations, and wherein the quality of the output is based on a level of deviation from a reference format of the second data within the output; and
update the ML model using the one or more metrics.

2. The system of claim 1, wherein the one or more processors further:
receive, from a plurality of computing devices, the first matrix comprising a plurality of operations and associated entity data; and
execute, using the associated entity data, the plurality of operations within the third matrix.

3. The system of claim 1, wherein the one or more processors further:
access a database to retrieve data from a plurality of data sources associated with the execution of the operations, wherein the data includes structured data, temporal data, and external data.

4. The system of claim 3, wherein the one or more processors further:
identify errors corresponding to the data from the plurality of data sources within the database, the errors correspond to values not in accordance with a format for the ML model; and
execute the ML model to determine values to correct the error by using a subset of the plurality of data sources.

5. The system of claim 4, wherein the one or more processors further:
generate an indicator to assign to a value of the data corresponding to the error, the indicator indicating missing data within the database.

6. The system of claim 3, wherein the one or more processors further:
detect an error within the data from the plurality of data sources, the error indicating at least one of an inconsistency, duplicate, or missing value associated with the data; and
query the database to obtain at least one reference to correct the error within the data.

7. The system of claim 3, wherein the one or more processors further:
generate a user interface configured with a filter to include the data associated with the execution of the operations based on one or more conditions, the one or more conditions corresponding to types of filters, including relevance, temporal, status, or priority.

8. The system of claim 1, wherein the one or more processors further:
transmit, for display on a user interface of the computing devices, the third matrix.

9. The system of claim 1, wherein the one or more processors further:
receive, from the computing devices, feedback associated with the third matrix and a generated user interface, the feedback including the one or more metrics; and
update the operations within a validation dataset based on the feedback.

10. The system of claim 9, wherein the one or more processors further:
train the ML model to identify a format for the data by applying a training dataset to the ML model, the training dataset including incorrect formats of training data and correct formats of the training data.

11. A computer-implemented method comprising:
accessing, by one or more processors, a first matrix to control execution of operations, the execution of operations based on associated entity data;
transforming, by the one or more processors, the first matrix into a second matrix corresponding to an input for a machine learning (ML) model;
generating, by the one or more processors using the ML model, an output based on the second matrix, wherein generating the output comprises applying the second matrix as an input to the ML model, wherein the output comprises a third matrix corresponding to one or more operations for the associated entity data, a priority for each operation in the one or more operations, and one or more resources to execute the one or more operations;
identifying, by the one or more processors using the ML model, from a computing device, one or more metrics that indicates compatibility of the output, accuracy of the output, and quality of the output, wherein compatibility of the output is determined based on an interaction with the output, wherein accuracy of the output is determined based on a level of deviation from reference entity data and reference operations, wherein quality of the output is based on a level of deviation from a reference format of the second data within the output; and
updating, by the one or more processors, the ML model using the one or more metrics.

12. The method of claim 11, further comprising:
receiving, by the one or more processors from a plurality of computing devices, the first matrix comprising a plurality of operations and associated entity data; and
executing, by the one or more processors using the associated entity data, the plurality of operations within the third matrix.

13. The method of claim 11, further comprises accessing, by the one or more processors, a database to retrieve data from a plurality of data sources associated with the execution of the operations, wherein the data includes structured data, temporal data, and external data.

14. The method of claim 13, further comprising:
identifying, by the one or more processors, errors corresponding to the data from the plurality of data sources within the database, the errors correspond to values not in accordance with a format for the ML model; and
executing, by the one or more processors, the ML model to determine values to correct the error by using a subset of the plurality of data sources.

15. The method of claim 14, further comprising:
generating, by the one or more processors, an indicator to assign to a value of the data corresponding to the error, the indicator indicating missing data within the database.

16. The method of claim 13, further comprising:
detecting, by the one or more processors, an error within the data from the plurality data sources, the error indicating at least one of an inconsistency, duplicate, or missing value associated with the data; and
querying, by the one or more processors, the database to obtain at least one reference to correct the error within the data.

17. The method of claim 13, further comprises generating, by the one or more processors, a user interface configured with a filter to include the data associated with the execution of the operations based on one or more conditions, the one or more conditions corresponding to types of filters including relevance, temporal, status, or priority.

18. The method of claim 11, further comprises transmitting, by the one or more processors, for display on a user interface of the computing devices, the third matrix.

19. The method of claim 11, further comprising:
receiving, by the one or more processors from the computing devices, feedback associated with the third matrix and a generated user interface, the feedback including the one or more metrics; and
updating, by the one or more processors, the operations within a validation dataset based on the feedback.

20. A non-transitory computer-readable medium comprising processor readable instructions, such that, when executed by a processor, causes the processor to:
access a first matrix to control execution of operations, the execution of operations based on associated entity data;
transform the first matrix into a second matrix corresponding to an input for a machine learning (ML) model;
generate, using the ML model, an output based on the second matrix, wherein generating the output comprises applying the second matrix as an input to the ML model, wherein the output comprises a third matrix corresponding to one or more operations for the associated entity data, a priority for each operation in the one or more operations, and one or more resources to execute the one or more operations;
identify, by the ML model, one or more metrics that indicates compatibility of the output, accuracy of the output, and quality of the output, wherein compatibility of the output is determined based on an interaction with the output, wherein accuracy of the output is determined based on a level of deviation from reference entity data and reference operations, wherein quality of the output is based on a level of deviation from a reference format of the second data within the output; and
update the ML model using the metric.
